(19) United States
(12) Patent Application Publication
(10) Pub. No.: US 2026/0134262 A1
(43) Pub. Date: May 14, 2026

(54) DETERMINING UNIFORM RESOURCE LOCATOR (URL) CHARACTERISTICS USING GENERATIVE ARTIFICIAL INTELLIGENCE (AI) MODELS

(71) Applicant: Microsoft Technology Licensing, LLC, Redmond, WA (US)

(72) Inventors: Siarhei ALONICHAU, Seattle, WA (US); Aliaksei BONDARIONOK, Redmond, WA (US)

(21) Appl. No.: 18/943,558

(22) Filed: Nov. 11, 2024

(51) Int. Cl. G06N 3/0475; G06N 3/048; G06N 3/0499; G06N 3/096

(52) U.S. Cl. CPC G06N 3/0475; G06N 3/048; G06N 3/0499; G06N 3/096

(57) ABSTRACT

This disclosure describes a URL understanding system that determines the value and characteristics of newly discovered URLs. For example, upon discovering a new URL, the URL understanding system quickly determines whether to add the new URL to a URL index (e.g., a URL search index). In various implementations, the URL understanding system can quickly determine the qualities and characteristics of new URLs using multiple language-based generative AI models. For instance, the URL language model builds a URL language model to learn the syntax and structure of URL strings (e.g., a “URL language”). Then, building upon the URL language, the URL understanding system creates a URL prediction model that determines URL characteristics. Based on one or more characteristics, the URL understanding system can perform various actions, such as quickly adding new URLs to a URL index.

### BACKGROUND

In recent years, advancements in hardware and software have significantly transformed machine learning, particularly in the development of generative artificial intelligence (AI) models. These models have found widespread applications, especially in language-based tasks like natural language processing (NLP). However, many potential uses of generative AI remain unexplored.

### BRIEF DESCRIPTION OF THE DRAWINGS

The following detailed description provides example implementations accompanied by drawings. Additionally, each of the figures listed below corresponds to one or more implementations discussed in this disclosure.

FIG. 1 illustrates an example overview of implementing the uniform resource locator (URL) discovery system to determine the value and characteristics of newly discovered URLs, including whether to quickly add URLs to a URL index.

FIG. 2 illustrates an example computing environment of a cloud computing system where a URL understanding system is implemented.

FIG. 3 illustrates an example block diagram of generating URL identifier strings with a tokenizer model.

FIG. 4 illustrates an example diagram of training a URL language model to learn the syntax and structure of URL strings.

FIG. 5 illustrates an example diagram of training a URL prediction model based on the weights and parameters of the URL language model.

FIG. 6 illustrates an example diagram of determining whether to add a new URL to a URL index using the URL prediction model.

FIG. 7 illustrates an example series of acts for determining uniform resource locator (URL) characteristics using generative artificial intelligence (AI) models.

FIG. 8 illustrates example components included within a computer system that implements the URL understanding system.

### DETAILED DESCRIPTION

This disclosure describes a URL understanding system that determines the value and characteristics of newly discovered URLs. For example, upon discovering a new URL, the URL understanding system quickly, efficiently, and accurately determines whether to add the new URL to a URL index (e.g., a URL search index). In various implementations, the URL understanding system can quickly determine the qualities and characteristics of new URLs using multiple language-based generative AI models. For instance, the URL understanding system builds a URL language model to learn the syntax and structure of URL strings (e.g., a “URL language”). Building upon the URL language, the URL understanding system creates a URL prediction model that determines URL characteristics. Based on one or more characteristics, the URL understanding system can perform various actions, such as adding new URLs to a URL index shortly after the discovery of the new URLs.

Accordingly, implementations of the present disclosure provide benefits and solve problems in the art with systems, computer-readable media, and computer-implemented methods that utilize a URL understanding system to determine and apply URL characteristics using language-based generative AI models. As described below, the URL understanding system builds and updates multiple language-based generative AI models to quickly and accurately process newly discovered URLs. For example, the URL understanding system can determine in near-real-time when to add newly discovered URLs to a URL search index, as further described below.

To elaborate, consider this example of the URL understanding system determining URL characteristics using generative AI models. In various implementations, the URL understanding system generates a URL language model to predict the syntax and structure of URL strings. The URL understanding system also generates a URL prediction model based on tuned weights and parameters of the URL language model to determine the selection probabilities of URLs. Next, in response to identifying a new URL, the URL understanding system determines a selection probability for the new URL (e.g., a URL not in a URL search index) using the URL prediction model. Based on the selection probability for the new URL meeting a selection probability threshold, the URL understanding system can add the new URL to a URL search index.

As described in this disclosure, the URL understanding system provides several significant technical benefits in terms of improved computing accuracy and efficiency compared to existing URL indexing approaches. For example, upon discovering new URLs, current approaches often require days or weeks to analyze the URLs and perform corresponding actions. Many current approaches take several days, at best, to determine whether to add new URLs to a URL search index. These delays introduce inefficiencies in search systems that cannot leverage the newly discovered URLs, which are waiting to be processed and evaluated.

One major problem with current URL indexing approaches is their inability to deeply understand the syntax and structure (e.g., hierarchy) of URLs. Because of this, current approaches analyze new URLs separately based on several factors (e.g., content quality, technical factors, authority, trustworthiness, freshness, probability, and user experience). To understand many of these factors, current approaches need to spend significant amounts of computational resources exploring the new URLs. Additionally, many current approaches require further computational resources to determine if the balance of factors warrants performing additional actions based on a URL. As mentioned above, many current approaches require significant time and resources to analyze and implement newly discovered URLs.

In contrast to existing systems, the URL understanding system quickly processes and understands the deep contexts, structures, and syntax of newly discovered URLs. In particular, the URL understanding system builds a URL language model to understand URLs as it would a language. For instance, by treating URLs as “sentences,” the URL understanding system can train a URL language model to learn the syntax, structure (e.g., hierarchy), and “grammar” of URLs as it would with another language. Once the URL language is learned, the URL understanding system can perform more complex processing tasks on newly discovered URLs. As a result, the URL understanding system is able to determine URL characteristics more quickly and accurately than current approaches.

In various implementations, the URL understanding system creates and utilizes language-based generative AI models to first understand URLs on a deeper level and then use that understanding to perform additional tasks. For example, the URL understanding system fine-tunes the parameters of a URL language model to learn the language of URLs. Those weights and parameters are then copied to a URL prediction model, which has additional layers for performing specific tasks. By using the tuned weights and parameters of the URL language model in the URL prediction model, the URL prediction model starts with a substantial efficiency and accuracy advantage over current approaches that still struggle to understand URLs. Because the URL prediction model begins with a solid understanding of URLs, it is able to more quickly generate accurate determinations regarding URL characteristics.

Utilizing the trained language-based generative AI models, the URL understanding system can determine whether to add newly discovered URLs to a search index in near-real time (rather than days or weeks). Indeed, the URL understanding system can quickly and efficiently achieve a holistic picture of newly discovered URLs, which allows the URL understanding system to quickly perform actions, such as quickly adding high-quality URLs to a URL search index. As another benefit, the freshness of the URL search index is significantly improved as higher-quality URLs are added more quickly as a result of implementing the URL understanding system.

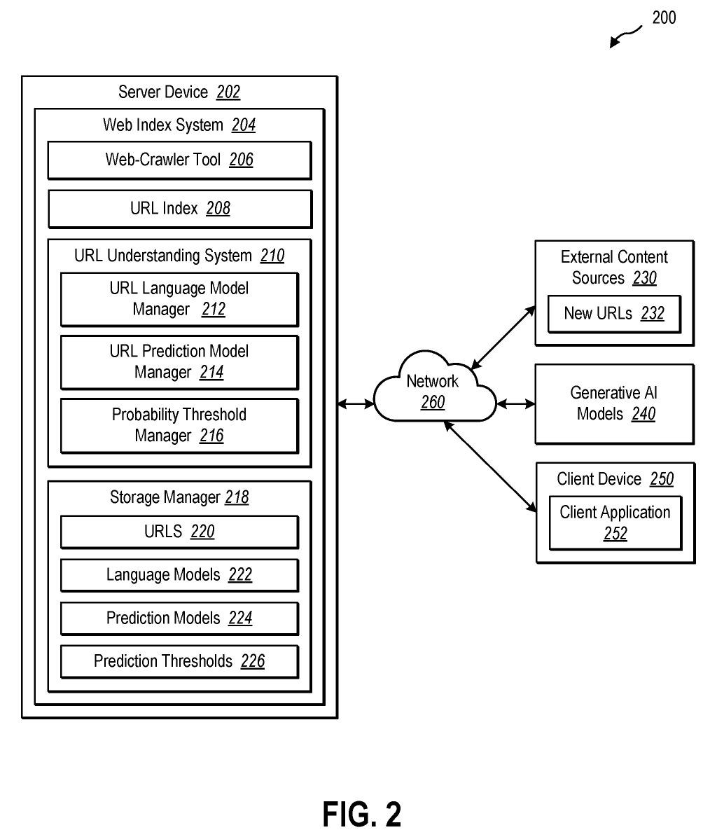

As illustrated in the foregoing discussion, this disclosure utilizes a variety of terms to describe the features and advantages of the URL understanding system. To illustrate, this disclosure describes the URL understanding system in the context of a cloud computing system. As an example, the term “cloud computing system” refers to a network of interconnected computing devices that provide various services and applications to other computing devices (e.g., server devices and client devices) inside or outside of the cloud computing system. An example of a cloud computing system is described below in connection with FIG. 2.

As an example, the term “URL web discovery” refers to the process of finding and identifying new or updated web pages (e.g., URLs). URL web discovery is commonly performed by web crawlers (e.g., by crawling existing web pages). As another example, the term “search engine indexing” refers to collecting, parsing, and storing data to facilitate fast and accurate information retrieval by creating a searchable database of web content. Newly discovered URLs determined to be above a selection probability threshold are added to a URL search index used by search or web indexing systems.

As an example, the term “URL string” refers to the terms and/or characters that make up a URL. A URL string can include a set of tokens making up the URL. As another example, a “URL identifier string” refers to a series of identifiers that represent a URL. For example, a URL identifier string includes a set of identifiers corresponding to the tokens, terms, or characters in a URL string.

As an example, the term “selection probability” refers to the likelihood or percentage that a URL link will be selected when presented in a set of search results. In some instances, selection probability includes click probability.

As an example, the term “generative artificial intelligence model” (or “generative AI model”) refers to an artificial intelligence computational system that utilizes deep learning and a large number of parameters (e.g., billions or trillions for a large version and fewer for a small version) trained on one or more extensive datasets to produce coherent, contextually relevant, and fluent topic-specific outputs (e.g., text and/or images). In many instances, a generative AI model refers to an advanced computational system that uses natural language processing, machine learning, and/or image processing to generate coherent and contextually relevant human-like responses.

As an example, a “generative artificial intelligence model” (or “generative AI model”) refers to a computational system that utilizes deep learning and a large number of parameters (e.g., billions or trillions for a large version and fewer for a small version) trained on one or more extensive datasets to produce coherent, contextually relevant, and fluent outputs (e.g., text and/or images) specific to a particular topic. In many cases, a generative AI model is an advanced computational system that uses natural language processing, machine learning, and/or image processing to generate human-like responses that are coherent and contextually relevant. For instance, generative AI models can create outputs in various formats, including one-word answers, long narratives, images, videos, labeled datasets, documents, tables, and presentations. Generative AI models can include language-based models such as a URL language model and a URL prediction model, which interpret URLs as sentences, as further described below.

Moreover, generative AI models are primarily based on transformer architectures for understanding, generating, and manipulating human language. Generative AI models can also utilize other types of architectures such as RNN architecture, long short-term memory (LSTM) model architecture, CNN architecture, or other types of architectures. Examples of generative AI models include generative pre-trained transformer (GPT) models like GPT-3.5, GPT-4, and GPT-4o, Phi-Silica, Phi-3, bidirectional encoder representations from transformers (BERT) models, text-to-text transfer transformer models like T5, conditional transformer language (CTRL) models, and Turing-NLG. Other types of generative AI models include sequence-to-sequence models (Seq2Seq), vanilla RNNs, and LSTM networks. In some instances, a generative AI model includes a large language model (LLM), a large action model (LAM), a small language model (SLM), and a small action model (SAM), which serve as text-based versions of a generative AI model, such as those that receive input prompts and generate output responses in the form of text, images, audio, and/or actions.

As another example, the terms “prompt,” “model prompt,” or “generative AI model prompt” refer to a request provided to a generative AI model to create generative AI model output based on plain language guidance prompts. Examples of prompts are further described below.

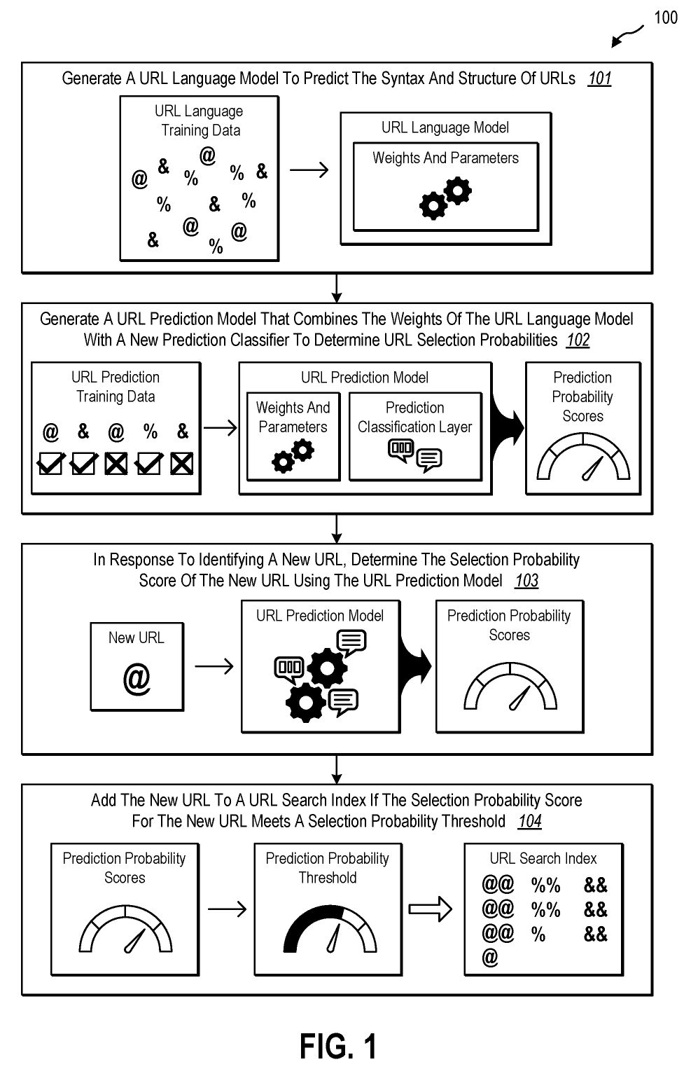

Additional example implementations and details of the URL understanding system are discussed in connection with the accompanying figures, which are described next. For instance, FIG. 1 illustrates an example overview of implementing the uniform resource locator (URL) discovery system to determine the value and characteristics of newly discovered URLs, including whether to quickly add URLs to a URL index according to some implementations. FIG. 1 includes a series of acts 100 performed by the URL understanding system within a cloud computing system or environment. While the series of acts 100 provides a high-level overview of the URL understanding system, additional details are provided in connection with subsequent figures.

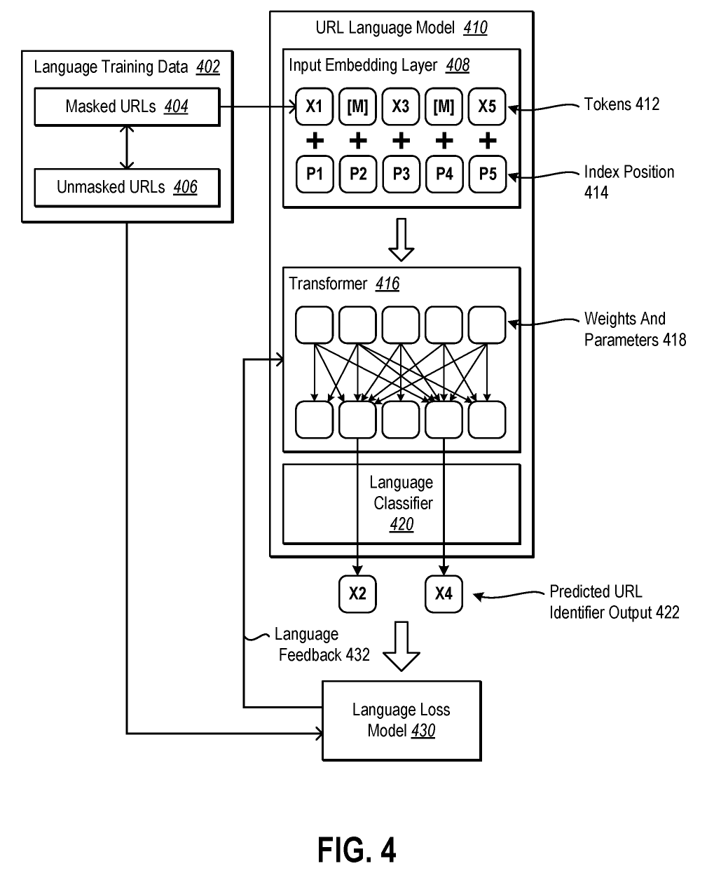

As shown, the series of acts 100 includes act 101 of generating a URL language model to predict the syntax and structure of URLs. For example, the URL understanding system obtains a set of URL language training data and trains a URL model (e.g., the weights and parameters of the model) to learn the syntax and attributes of URL strings. In addition, the URL language model inherently learns the likelihood of a URL being selected based on using selected URLs within the training data. As described below, the URL language model may be a masked language model or a causal language model (e.g., types of generative AI models). Additional details regarding generating the URL language model are provided in connection with FIG. 4.

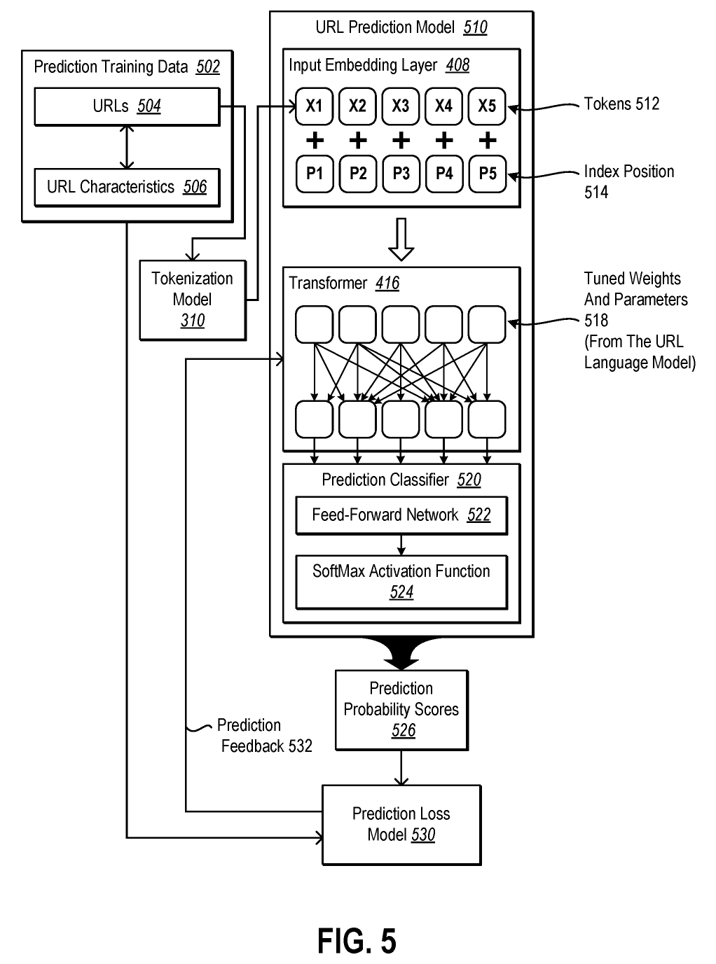

Act 102 includes generating a URL prediction model that combines the weights of the URL language model with a new prediction classifier to determine URL selection probabilities. For example, the URL understanding system duplicates the weights and parameters from the URL language model into the URL prediction model, adds a prediction classifier layer, and trains at least the classification layer to determine prediction probability scores using URL prediction training data. As described below, the URL prediction model combines the URL language knowledge of the URL language model with additional classification prediction tasks to quickly and efficiently determine the characteristics and attributes of URLs. Additional details regarding generating the URL prediction model are provided in connection with FIG. 5.

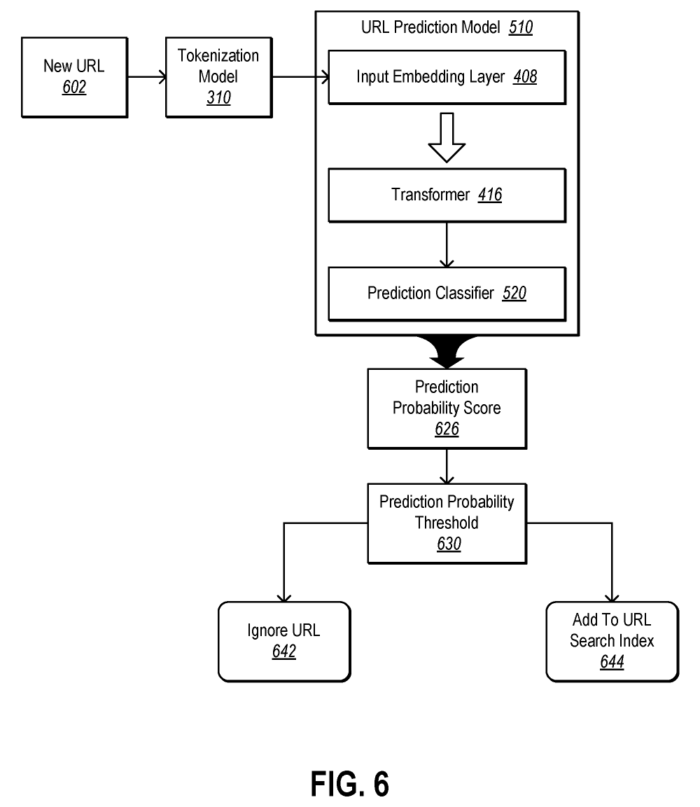

Once the URL prediction model is trained, the URL understanding system can use it on newly discovered URLs. For example, act 103 includes, in response to identifying a new URL, determining the selection probability score of the new URL using the URL prediction model. For instance, the URL understanding system provides a new URL to the URL prediction model to generate a selection probability score for the new URL. Additional details regarding implementing the URL language model are provided in connection with FIG. 6.

Act 104 includes adding the new URL to a URL search index if the selection probability score for the new URL meets a selection probability threshold. For example, the URL understanding system compares the selection probability score for the new URL to a prediction probability threshold to determine if the new URL should be included in a URL search index. If so, the new URL will be included in future searches that access the updated URL search index. Additional details regarding comparing prediction probability scores to prediction probability thresholds are provided in connection with FIG. 6.

With a general overview in place, additional details are provided regarding the components, features, and elements of the uniform resource locator (URL) discovery system. In particular, FIG. 2 illustrates an example computing environment where a URL understanding system is implemented in a cloud computing system according to some implementations. In particular, FIG. 2 illustrates an example of a computing environment 200 with various computing devices, including a server device 202 associated with a URL understanding system 210, external content sources 230, generative AI models 240, and a client device 250, connected via a network 260. Later figures provide examples of various functions and actions performed by the URL understanding system.

As shown in FIG. 2, the URL understanding system 210 operates within a computing environment 200 that includes a server device 202. The server device 202 includes various systems, including the URL understanding system 210. While FIG. 2 shows example arrangements and configurations of devices and systems, other arrangements and configurations are possible.

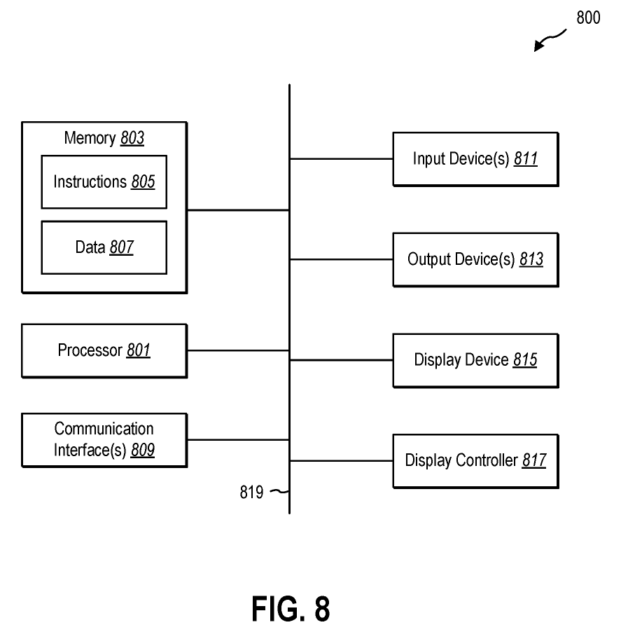

Many of the components shown may be implemented on one or more computing devices, such as one or more server devices. In various implementations, some of these components (e.g., a generative AI models 240 and the client device 250) represent multiple component instances or versions (e.g., the generative AI models 240 represent different generative models). In some instances, one or more components may be implemented on a personal device (e.g., the generative AI model may be a small generative model located on a client device). Further details regarding computing devices are provided below in connection with FIG. 8, which also includes additional details regarding networks, such as the network 260 shown.

Before describing the components of the server device 202, including the URL understanding system 210, other components of the computing environment 200 are discussed first to provide better context when describing the URL understanding system 210. For example, the external content sources 230 include external content accessible via the Internet. As shown, the external content sources 230 include new URLs 232. For instance, the external content sources 230 provide content that includes URL links, which the URL understanding system 210 evaluates to determine how to efficiently utilize the URLs.

Additionally, the generative AI models 240, which may represent multiple generative models or model instances, produce generative outputs (e.g., AI model outputs) based on prompt inputs (e.g., AI model prompts). For instance, the generative AI models 240 include a URL language model and a URL prediction model, which may be language-based generative AI models. In some instances, the generative AI models 240 can represent both large and small generative AI models.

As shown, the computing environment 200 includes the client device 250 with a client application 252. In various instances, the client device 250 includes a client application 252, such as a web browser, mobile application, or another type of computer application used to access and/or interact with the server device 202 and/or the web indexing system 204. In various implementations, the client device 250 is associated with a user (e.g., a user’s client device), such as a user who regularly engages in web browsing activity using the client application 252.

Returning to the server device 202, as shown, the server device 202 includes a web indexing system 204 having a web crawler tool 206, a URL index 208, and the URL understanding system 210. In various implementations, the web indexing system 204 facilitates the discovery of new URLs. For example, the web indexing system 204 directs URL searching, crawling, and storing URLs. In various implementations, the web indexing system 204 performs search engine indexing.

In various implementations, the URL index 208 stores URLs and corresponding information. In some instances, the URL index 208 is a database or datastore that uses the web indexing system 204 to store and organize information about web pages. When a URL is indexed, it means the search engine has analyzed the page’s content and metadata, making it searchable and retrievable for relevant queries. This process helps ensure that users find the most relevant and up-to-date information when they perform a search.

In various implementations, including the illustrated implementation, the URL understanding system 210 includes various components and elements that are implemented in hardware and/or software. For example, the URL understanding system 210 includes a URL language model manager 212, a URL prediction model manager 214, a probability threshold manager 216, and a storage manager 218. The storage manager 218 includes URLs 220, language models 222, prediction models 224, and prediction thresholds 226. In various implementations, one or more of the URL prediction model and/or the URL language model is located outside of the URL understanding system 210, such as with the generative AI models 240.

In various implementations, the URL language model manager 212 facilitates generating, training, and updating language models 222 (e.g., URL generative AI language models). For example, the URL language model manager 212 uses locally stored language models or remotely located language models (e.g., from the generative AI models 240). In addition, the URL language model manager 212 uses the language models 222 to learn the syntax, structure, and context of URLs, as described below.

In one or more implementations, the URL prediction model manager 214 facilitates generating, training, and updating prediction models 224 (e.g., URL generative AI prediction models). For example, the URL prediction model manager 214 uses locally stored prediction models or remotely located prediction models (e.g., from the generative AI models 240) to generate various predicted probabilities for URLs 220 (e.g., the new URLs 232), as described below.

In various implementations, the probability threshold manager 216 facilitates determining which actions to perform for the URLs 220. For example, the probability threshold manager 216 uses prediction thresholds 226 to determine whether to use a newly discovered URL or how to optimally leverage the information in the URL for the benefit of the web indexing system 204.

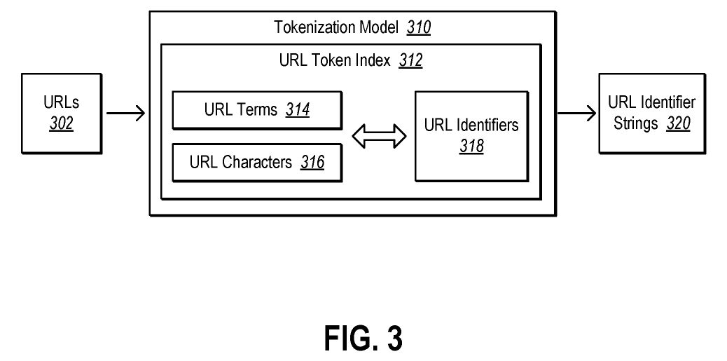

FIG. 3 through FIG. 6 provide additional details about the URL understanding system 210 quickly and efficiently determining URL characteristics and attributes from new URLs, and the actions to perform based on the determined characteristics. For example, FIG. 3 provides additional details about tokenizing uniform resource locators (URLs) into a suitable input for generative AI models, FIG. 4 provides details about generating a URL language model, FIG. 5 provides details about generating a URL prediction model, and FIG. 6 provides additional details about implementing the URL prediction model and determining actions based on the characteristics of newly discovered URLs.

To begin, FIG. 3 illustrates an example block diagram of generating URL identifier strings with a tokenizer model according to some implementations. As shown, FIG. 3 includes a tokenization model 310 that converts URLs 302 into URL identifier strings 320. Tokenizing URLs into identifier strings allows for providing the URL language models and URL prediction models with a more compatible input format while still preserving the sentence structure of URL strings.

To elaborate, the URL understanding system 210 obtains URLs 302. The URLs 302 may be from a URL search index, a list of discovered URLs, a corpus of URLs, or another URL collection. The URLs 302 should have a distribution that matches the URLs found across the Internet or with websites associated with the web indexing system.

As shown, the URL understanding system 210 provides the URLs 302 to the tokenization model 310. In various implementations, the tokenization model 310 includes a URL token index 312. The role of the URL token index 312 is to convert URL terms 314 and URL characters 316 into URL identifiers 318. The URL token index 312 is large enough to cover all possible combinations of characters in a URL string, but not so large as require significant computational resources when mapping URL tokens or classifying encoded tokens to each entry in the index, as described below.

In various implementations, the URL understanding system generates URL terms 314 by analyzing a large set of URLs and determining the most frequently occurring character strings. For example, the URL understanding system identifies the top 100,000 URL terms (or another number). The URL understanding system 210 may then map each URL term to a URL identifier.

Similarly, for the remaining strings of characteristics in a URL, the URL understanding system maps sets of one character, two characters, three characters, or more sequential characters to URL identifiers. In this way, every character or set of characters in a URL can be mapped to a URL identifier. By putting the URL identifiers together, a tokenized URL can form a series of URL identifiers (a URL identifier string).

To illustrate, the URL understanding system 210 provides a URL to the tokenization model 310. The tokenization model 310 analyzes the string of characters for the URL and identifies URL terms 314 and URL characters 316, which are mapped into URL identifiers 318. The tokenization model 310 then concatenates or combines the URL identifiers 318 into a URL identifier string. In this way, the URL understanding system 210 tokenizes the URLs 302 into URL identifier strings 320.

As mentioned above, FIG. 4 provides additional details regarding generating the URL language model. In particular, FIG. 4 illustrates an example diagram of training a URL language model to learn the syntax and structure (e.g., hierarchy) of URL strings according to some implementations.

As explained earlier, the URL understanding system 210 creates a URL language model that learns the syntax, structure, and contexts of URLs, similar to how a language model learns the syntax, structure, and contexts of natural languages (e.g., English, Spanish, Japanese, Chinese, German, or Latin). In particular, the URL language model 410 learns a URL language by treating URLs as sentences, as further described below.

As shown, FIG. 4 includes language training data 402, a URL language model 410 (e.g., a URL generative AI language model), and a language loss model 430. The language training data 402 includes masked URLs 404 and unmasked URLs 406.

In one or more implementations, the URL language model 410 is a masked language model that is trained by masking some of the tokens in the input and then predicting those masked tokens. In these instances, the masked language model uses bidirectional context, meaning it can utilize information from both the left and right of the masked token to make predictions. For example, the URL language model 410 includes bidirectional encoder representations from the transformer architecture.

To elaborate, in various implementations, the URL understanding system 210 converts a set of URLs into a set of URL identifier strings (e.g., token strings) to create the language training data 402. The URL understanding system 210 saves the URL identifier strings as the unmasked URLs 406, which serve as ground truths during training. To create the masked URLs 404, the URL understanding system 210 duplicates the unmasked URLs 406 and changes the URL identifier of at least one token in each string to a default masked identifier value (or an incorrect identifier value).

The URL language model 410 includes an input embedding layer 408, a transformer 416, and a language classifier 420. The input embedding layer 408 receives a masked string of URL identifiers and parses the tokens 412 from the URL identifier string. Some of the tokens 412 in the layer 408 are masked tokens (shown as “[M]”). In some instances, the input embedding layer 408 also embeds each of the tokens 412 with an index position 414, as shown.

In various implementations, the transformer 416 includes encoding elements (e.g., components, nodes, and/or connections) that encode the tokenized input. In particular, the encoding elements include weights and parameters 418 that start with random values (or default values) and are tuned to cause the transformer 416 to accurately encode the masked URLs 404. As noted above, the transformer 416 can include a bidirectional transformer encoder that tunes the weights and parameters 418 to learn bidirectional context.

As shown, the language classifier 420 generates a predicted URL identifier output 422 for the masked tokens. In one or more implementations, the language classifier 420 includes classifier components, such as a SoftMax classifier (e.g., SoftMax activation function), which determines the probability that an encoded token matches each of the possible URL identifiers. In some implementations, the language classifier 420 may include a different type of classifier.

Based on the predicted URL identifier output 422, the URL understanding system 210 trains the URL language model 410 to learn to predict the masked tokens. For example, the URL understanding system 210 uses a loss model that compares the predicted URL identifier output 422 to the corresponding unmasked URL identifiers from the unmasked URLs 406. The language loss model 430 provides language feedback 432 to the transformer 416, which is applied to the weights and parameters 418 of at least the transformer 416. The URL understanding system 210 iterates the process until a threshold condition is met (e.g., the number of iterations, model convergence, or a time limit).

Additionally, in various implementations, the language training data 402 is based on a set of collected URLs, many of which are included as training data after being detected as selected URLs. In these implementations, because the language training data 402 may be biased toward selected URLs (e.g., URLs clicked by a user), the URL language model 410 also learns to inherently understand selection probabilities and likelihoods. Indeed, the URL language model 410 is trained to understand the syntax of real URLs as well as to inherently predict which URLs are more likely to be selected or otherwise used by a user. This also allows the model to produce more accurate predictions and determinations for URLs that are more likely to be selected.

In some implementations, the URL language model 410 is a causal language model. In these instances, the model is trained to predict the next token in a sequence using only the previously received tokens of the target token. In some instances, the URL language model 410 follows a generative pre-trained transformer model that uses only the decoder portion of the transformer. Similarly, the URL language model 410 may include or be a different type of model that identifies masked tokens.

In various implementations, the URL understanding system 210 converts the predicted URL identifier output back into a URL. For example, the URL understanding system 210 uses the URL token index to reverse map the URL identifiers back into URL terms and URL characteristics. The URL understanding system 210 can then combine the predicted URL identifier output 422 with the known tokens to generate a URL, for instance, to test and evaluate the accuracy of the URL language model 410 training.

In training the URL language model 410 to predict masked tokens, the model learns the syntax, structure, and context of URLs as it would another language. In particular, by treating URLs the same as natural language sentences input into a generative language model, the URL language model 410 learns correct and incorrect URL usage. For example, the URL language model 410 learns that while “https://www.microsoft.com/en-us/” is a viable URL (e.g., a valid URL), “https://www.google.com/en-us/” is not (e.g., an invalid URL).

Additionally, the URL language model 410 learns the importance and authority of many webpages or websites, including webpages or websites that have a high level of authority and other webpages or websites that have lower authority levels. In some instances, the URL language model 410 also learns other important aspects of URL content, such as URL terms associated with freshness or terms associated with less recent content. This URL context information is embedded into the weights and parameters of the transformer 416.

With the URL language model 410 trained to understand URLs as a language, the URL understanding system 210 can use transfer learning to perform additional tasks and operations on URLs. For example, the URL understanding system 210 builds a URL prediction model that determines predictions based on input URLs, as described next.

As mentioned above, FIG. 5 provides additional details regarding generating the URL prediction model. In particular, FIG. 5 illustrates an example diagram of training a URL prediction model based on the weights and parameters of the URL language model according to some implementations.

To illustrate, FIG. 5 includes prediction training data 502, the tokenization model 310, a URL prediction model 510, and a prediction loss model 530. The prediction training data 502 includes URLs 504 and URL characteristics 506. In various implementations, the URL characteristics 506 correspond to a selection probability (e.g., click rate). In these implementations, the URL characteristics 506 indicate whether a corresponding URL has been selected.

In various implementations, the URL characteristics 506 may include different or additional URL characteristics, depending on what the URL understanding system 210 is training the URL prediction model 510 to predict. For instance, the URL characteristics 506 may include HTTP status codes associated with a URL (e.g., 2XX success status codes, 3XX redirection status codes, 4XX client error status codes, or 5XX server error status codes). In one or more instances, the URL characteristics 506 indicate whether the URL content changes over 5 days, 15 days, 30 days, or another duration.

Furthermore, the URL characteristics 506 can indicate whether a URL is junk, spam, or includes adult content. In various instances, the URL characteristics 506 include whether a URL has quality content, fresh content, or outdated content. In one or more instances, the URL characteristics 506 indicate whether a URL has out-links and/or out-links that change frequently. In some instances, the URL characteristics 506 are associated with URLs appearing (or not) on the web indexing system’s enhanced generative search results page. In various instances, the URL characteristics 506 are associated with URL type information, URL network information and status, URL longevity, or the longevity of included links of the URLs.

As shown, the URL prediction model 510 includes an input embedding layer 408, the transformer 416, and a prediction classifier 520. As shown, the transformer 416 matches those from the URL language model 410. In many implementations, once the URL language model 410 is trained, the URL understanding system 210 copies or duplicates the transformer 416, including the tuned weights and parameters 518 as the foundation of the URL prediction model 510. For instance, the URL understanding system 210 applies transfer learning from the transformer 416 in the URL language model 410 to the transformer in the URL prediction model 510.

To elaborate, in some implementations, the URL understanding system 210 creates the URL prediction model 510 by copying or duplicating the trained URL language model but replacing the language classifier 420 with the prediction classifier 520. By using the tuned weights and parameters 518, the URL prediction model 510 begins with a complex understanding of URLs (e.g., their context, syntax, structure, and/or hierarchy), which allows the URL prediction model 510 to perform deeper-level projections on URLs.

As mentioned, the URL prediction model 510 includes an input embedding layer 408. In one or more implementations, the input embedding layer 408 parses the URL inputs (e.g., URL identifier strings created by the tokenization model 310 from the URLs 504) into tokens 512 and assigns index positions 514 to each token. In some implementations, the URL prediction model 510 includes the same input embedding layer 408 as the URL language model 410. In one or more implementations, the input embedding layer may have a different architecture or structure. The input embedding layer 408 provides position-indicated tokens to the transformer 416 for further processing.

As shown, the URL prediction model 510 generates prediction probability scores 526 for the URLs 504. In various implementations, the prediction classifier 520 includes a feed-forward network 522 and a SoftMax activation function 524. In some implementations, the prediction classifier 520 includes additional and/or different components. For example, the prediction classifier 520 may include a sigmoid function or another classification function. In many implementations, the prediction classifier 520 determines the probability that a URL encoded (and/or decoded) by the transformer 416 matches one or more of the URL characteristics 506.

The URL understanding system 210 may train the URL prediction model 510 using the URL identifier strings 320. For example, the prediction loss model 530 uses one or more loss functions to determine a loss amount by comparing a prediction probability score generated by the URL prediction model 510 for an input URL to its corresponding URL characteristic (e.g., its ground truth). The URL understanding system 210 can use the prediction feedback 532 to train and fine-tune the URL prediction model 510.

In various implementations, the prediction feedback 532 is used to train each layer of the URL prediction model 510. In some implementations, the prediction feedback 532 is used to fine-tune the components of the prediction classifier 520 while the tuned weights and parameters 518 of the transformer 416 are fixed or frozen (e.g., not updated when training the URL prediction model 510). In some implementations, one or more selected weights and/or parameters of the transformer 416 are updated based on the prediction feedback 532 (e.g., a partial freeze).

As mentioned above, the URL understanding system 210 can create and/or train the URL prediction model 510 to perform a specific URL-based task. For example, when provided with a URL as input, the URL understanding system 210 trains the URL prediction model 510 to determine a selection probability score (e.g., click probability) for the URL (e.g., a prediction probability score).

The URL understanding system 210 can train the URL prediction model 510 to determine various URL characteristic predictions. For instance, the URL prediction model 510 is trained to determine the probability that a URL will appear on the web indexing system’s enhanced generative search results page or change over the next n-days (e.g., 5, 10, 15, 20, 30, 60, 75, 90, or 365). The URL prediction model 510 may be trained to determine when a URL will return a target HTTP status code (200: request successful, 201: new resource successfully created, 301: resource permanently moved to a new URL, 302: resource temporarily located at a different URL, 400: bad request due to invalid syntax, 404: requested resource not found, 500: server encountered an unexpected error, 503: server temporarily unable to handle the request).

Additionally, the URL prediction model 510 may be trained to determine if a URL is junk, spam, or includes adult content. The URL prediction model 510 may also be trained to evaluate whether a URL has quality content, is authoritative, has fresh content, has stale content, and/or includes misinformation. In some instances, the URL prediction model 510 is trained to determine information about URL type, URL network information and status, URL longevity, or the longevity of included links. Similarly, in some implementations, the URL prediction model 510 is trained to ascertain whether a URL has out-links and/or whether those out-links change frequently.

In various implementations, the URL understanding system 210 continues to train and update the URL language model 410 and the URL prediction model 510 as additional data is received. For example, the URL understanding system 210 updates the weights and parameters of the transformer in the URL language model 410 and then copies or duplicates the updated transformer to the URL prediction model 510. The URL understanding system 210 may also update and refine the prediction classifier 520 of the URL prediction model 510.

Once trained, the URL understanding system 210 uses the URL prediction model 510 to quickly determine target URL characteristics from URLs, including newly discovered URLs. To elaborate, FIG. 6 illustrates an example diagram of determining whether to add the new URL to a URL index using the URL prediction model according to some implementations.

As shown, the URL understanding system 210 obtains a new URL 602. For example, the new URL 602 was discovered in a web crawl, provided by a system or user, or updated from a previous URL. The URL understanding system 210 provides the new URL 602 to the tokenization model 310 to convert it into a URL identifier string. Because the URL token index in the tokenization model covers all possible combinations of characters in a URL string, the new URL 602 is successfully mapped to a string of URL identifiers.

As shown, the URL understanding system 210 provides the URL identifiers string to the URL prediction model 510 (e.g., a trained URL generative AI prediction model). The URL prediction model 510 utilizes the input embedding layer 408, the transformer 416, and the prediction classifier 520 to efficiently and accurately generate a prediction probability score 626 for the new URL 602. By treating the new URL 602 as an input sentence and using a generative AI model with a foundational understanding of URL language contexts, syntax, and structure, the URL understanding system 210 can efficiently and accurately generate probability determinations for target URL characteristics.

In addition, FIG. 6 includes determining whether to perform actions or operations for the new URL based on comparing the prediction probability score to one or more prediction probability thresholds. To elaborate, the URL understanding system 210 compares the prediction probability score 626 of the new URL 602 to a prediction probability threshold 630. In various implementations, the prediction probability threshold 630 includes a threshold value used to indicate whether a new URL includes a meaningful URL characteristic.

To illustrate, if the URL characteristic is selection probability (e.g., click probability), a prediction probability score 626 that meets or exceeds the prediction probability threshold 630 indicates that the new URL 602 includes a meaningful selection probability. In response, the URL understanding system 210 can perform an action, such as adding the new URL 602 to a URL search index (act 644). Otherwise, if the prediction probability score 626 is below the prediction probability threshold 630, the URL understanding system 210 may ignore or dismiss the URL (act 642), as URLs with prediction probability scores below the prediction probability threshold 630 are not included in the URL search index.

In some implementations, the prediction probability threshold 630 includes multiple thresholds for a URL characteristic. For example, the prediction probability threshold 630 includes a first threshold that, when met, indicates a first action (e.g., add the URL to the URL search index). The prediction probability threshold 630 also includes a second, higher threshold that, when met, indicates a second action or a modification of the first action (e.g., adding the URL to the URL search index immediately, on-the-fly, near-real time, or within a specific time frame (e.g., an hour, 3-5 hours, 12 hours, 24 hours)). In many instances, the second selection probability threshold is greater (e.g., has a higher probability score value) than the first selection probability threshold, and the second time period associated with the second selection probability threshold has a smaller or shorter duration than the first time period. The second action may complement or override the first action (e.g., place the URL in a first index rather than a second index).

The URL understanding system 210 can employ any number of thresholds and perform any number of corresponding actions. The threshold values and actions may vary based on the type of URL characteristic being determined for a new URL (e.g., the URL understanding system 210 can quickly identify and relegate spam or inappropriate URLs that would otherwise go initially undetected). Further, if the URL prediction model 510 is predicting multiple URL characteristics for the new URL, the URL understanding system 210 can compare the probability scores individually to separate corresponding thresholds or compare the combination of probability scores to a joint threshold value.

Returning to the illustrative example and FIG. 6, the URL understanding system 210 compares the prediction probability score 626 of the new URL 602 generated by the URL prediction model 510 to determine how to process the new URL 602. If the prediction probability threshold is met, the URL understanding system 210 adds the new URL 602 to a URL search index. In some instances, it may perform this action immediately (e.g., on-the-fly or near-real time) or within a short time period. Otherwise, the URL understanding system 210 can dismiss or ignore the new URL as not having a meaningful selection probability score that fails to meet the threshold.

Accordingly, the URL understanding system 210 can determine whether to add newly discovered URLs to a URL search index much more quickly than current approaches. Additionally, the URL understanding system 210 can significantly outperform current approaches by generating much more accurate prediction probability scores for new URLs for target URL characteristics due to utilizing a generative language model that has a much richer and more extensive understanding of URLs. Furthermore, being able to quickly add newly detected URLs to a URL search index improves the freshness (e.g., accuracy) of the URL search index, improves index selection, and allows the web indexing system to provide better search results using the improved URL search index. The benefit of performing on-the-fly or near-real-time operations for newly discovered URLs also extends to other areas of a web indexing system.

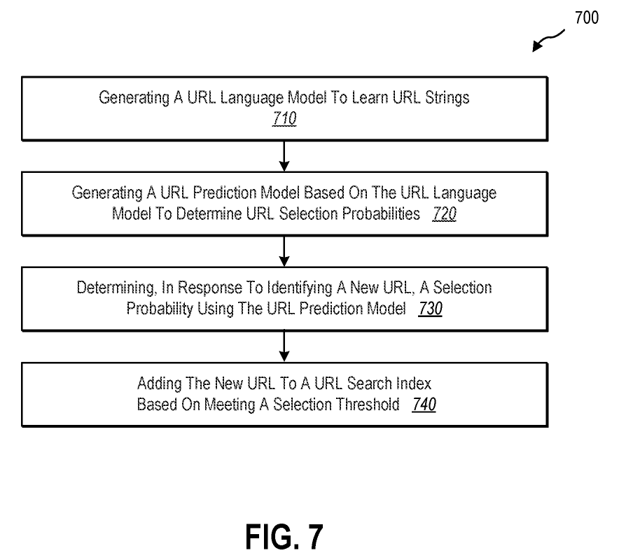

Turning now to FIG. 7, this figure illustrates an example series of acts for determining URL characteristics using generative AI models according to some implementations. While FIG. 7 illustrates acts according to one or more implementations, alternative implementations may omit, add to, reorder, and/or modify any of the acts shown.

The acts in FIG. 7 can be performed as part of a method (e.g., a computer-implemented method). Alternatively, a computer-readable medium can include instructions that, when executed by a processing system with a processor, cause a computing device to perform the acts in FIG. 7. In some implementations, a system (e.g., a processing system comprising a processor) can perform the acts in FIG. 7. For example, the system includes a processing system and computer memory with instructions that, when executed by the processing system, cause the system to perform various actions or steps.

As shown, the series of acts 700 includes act 710 of generating a URL language model to learn URL strings. For instance, in example implementations, act 710 involves generating a URL language model to predict the syntax and structure of URL strings. In various implementations, act 710 includes generating a URL language model by creating tuned weights and parameters of the URL language model to predict the syntax and structure of URL strings. In one or more implementations, the URL language model is a masking language model or a causal language model trained to predict URL tokens in URL token strings.

In some instances, act 710 includes generating a URL token index that includes URL terms and URL characters mapped to URL identifiers. In one or more implementations, act 710 includes generating a set of URL identifier strings by converting a set of URLs using a tokenization algorithm based on the URL token index. In various instances, generating the URL language model is based on using the set of URL identifier strings to create the tuned weights and parameters of the URL language model. In various implementations, generating the URL language model includes training the URL language model to inherently learn URL selection likelihoods (e.g., based on being trained with selected URLs). In some instances, generating the URL language model predicts the syntax and structure of URL strings based on the tuned weights and parameters by learning URL architecture, URL hierarchy, URL authority, and URL freshness.

As further shown, the series of acts 700 includes act 720 of generating a URL prediction model based on the URL language model to determine URL selection probabilities. For instance, in example implementations, act 720 involves generating a URL prediction model based on the tuned weights and parameters of the URL language model to determine the selection probabilities of URLs. In some implementations, act 720 includes generating a URL prediction model based on combining the tuned weights and parameters of the URL language model with a prediction classification layer to determine the selection probabilities of URLs.

In one or more implementations, in connection with act 720, generating the URL prediction model includes duplicating the tuned weights and parameters of the URL language model without duplicating the language classifier layer of the URL language model. In some instances, combining the tuned weights and parameters of the URL language model with a prediction classification layer includes adding a feed-forward layer and a SoftMax activation function to the tuned weights and parameters. In various implementations, generating the URL prediction model includes fine-tuning the prediction classification layer to determine the selection probabilities of the URLs.

In various implementations, generating the URL prediction model includes freezing the tuned weights and parameters while fine-tuning the prediction classification layer to determine the selection probabilities of the URLs. In some instances, generating the URL prediction model includes fine-tuning the prediction classification layer to determine additional probabilities of the URLs, including URL type information, URL network information, URL longevity, or included link longevity.

As further shown, the series of acts 700 includes act 730 of determining, in response to identifying a new URL, a selection probability using the URL prediction model. For instance, in example implementations, act 730 involves determining, in response to identifying a new URL (e.g., a not in a URL search index), a selection probability for the URL using the URL prediction model. In one or more implementations, act 730 includes determining a selection probability for the new URL not in a URL search index using the URL prediction model in response to identifying the new URL. In some implementations, act 730 includes identifying the new URL while crawling an existing webpage.

As shown further, the series of acts 700 includes act 740 of adding the new URL to a URL search index based on meeting a selection threshold. For instance, in example implementations, act 740 involves adding the new URL to a URL search index based on the selection probability for the new URL meeting a selection probability threshold.

In some instances, act 740 includes comparing the selection probability of the new URL to a selection probability threshold and, based on the selection probability for the new URL meeting the selection probability threshold, adding the new URL to the URL search index. In various implementations, adding the new URL to the URL search index occurs in near-real time upon determining that the selection probability of the new URL meets the selection probability threshold.

In some instances, comparing the selection probability of the new URL to the selection probability threshold includes comparing the selection probability of the new URL to a first selection probability threshold corresponding to adding URLs to the URL search index within a first time period. In various instances, comparing the selection probability of the new URL to the selection probability threshold includes comparing the selection probability of the new URL to a second selection probability threshold corresponding to adding URLs to the URL search index within a second time period, and the second selection probability threshold is greater than the first selection probability threshold. The second time period has a shorter or smaller duration than the first time period.

In some implementations, the series of acts 700 includes one or more additional acts. For example, the series of acts 700 includes determining an additional selection probability for the additional URL using the URL prediction model in response to identifying an additional URL and, based on determining that the additional selection probability does not meet the selection probability threshold, determining not to include the additional URL in the URL search index.

FIG. 8 illustrates certain components that may be included within a computer system 800. The computer system 800 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 800 represents one or more of the client devices, server devices, or other computing devices described above. For example, the computer system 800 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 800 includes a processing system including a processor 801. The processor 801 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 801 may be referred to as a central processing unit (CPU) and may cause computer-implemented instructions to be performed. Although the processor 801 shown is just a single processor in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 805 and the data 807 may be stored in the memory 803. The instructions 805 may be executable by the processor 801 to implement some or all of the functionality disclosed herein. Executing the instructions 805 may involve the use of the data 807 stored in the memory 803. Any of the various examples of modules and components described herein may be implemented, partially or wholly, as instructions 805 stored in memory 803 and executed by the processor 801. Any of the various examples of data described herein may be among the data 807 stored in memory 803 and used during the execution of the instructions 805 by the processor 801.

A computer system 800 may also include one or more communication interface(s) 809 for communicating with other electronic devices. The one or more communication interface(s) 809 may be based on wired communication technology, wireless communication technology, or both. Some examples of the one or more communication interface(s) 809 include a Universal Serial Bus (USB), an Ethernet adapter, a wireless adapter that operates according to an Institute of Electrical and Electronics Engineers (IEEE) 802.11 wireless communication protocol, a Bluetooth® wireless communication adapter, and an infrared (IR) communication port.

A computer system 800 may also include one or more input device(s) 811 and one or more output device(s) 813. Some examples of the one or more input device(s) 811 include a keyboard, mouse, microphone, remote control device, button, joystick, trackball, touchpad, and light pen. Some examples of the one or more output device(s) 813 include a speaker and a printer. A specific type of output device that is typically included in a computer system 800 is a display device 815. The display device 815 used with implementations disclosed herein may utilize any suitable image projection technology, such as liquid crystal display (LCD), light-emitting diode (LED), gas plasma, electroluminescence, or the like. A display controller 817 may also be provided to convert data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For clarity, the various buses are illustrated in FIG. 8 as a bus system 819.

This disclosure describes a subjective data application system within the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry the required program code in the form of computer-executable instructions or data structures, which can be accessed by a general-purpose or special-purpose computer.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or another data link that enables the transportation of electronic data between respective client devices and components (e.g., server devices and/or virtual machines thereon) of the cloud computing system.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Furthermore, upon reaching various computer system components, program code means in the form of computer-executable instructions or data structures can be automatically transferred from transmission media to non-transitory computer-readable storage media (devices), or vice versa. For example, computer-executable instructions or data structures received over a network or data link can be buffered in random-access memory (RAM) within a network interface module (NIC) and then eventually transferred to computer system RAM and/or to less volatile computer storage media (devices) at a computer system. Thus, it should be understood that computer-readable storage media (devices) can be included in computer system components that also (or even primarily) utilize transmission media.

The disclosure may be practiced in network computing environments with many types of computer system configurations, including personal computers, desktop computers, laptop computers, message processors, handheld devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available medium that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage, or other magnetic storage devices, or any other medium that can be used to store desired program code means in the form of computer-executable instructions or data structures and that can be accessed by a general-purpose or special-purpose computer.

The steps and/or actions of the methods described herein may be interchanged with one another without departing from the scope of the claims. In other words, unless a specific order of steps or actions is required for the proper operation of the method being described, the order and/or use of specific steps and/or actions may be modified without departing from the scope of the claims.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for determining uniform resource locator (URL) characteristics using generative artificial intelligence (AI) models, comprising:
generating a URL language model by creating tuned weights and parameters of the URL language model to predict syntax and structure of URL strings;
generating a URL prediction model based on combining the tuned weights and parameters of the URL language model with a prediction classification layer to determine selection probabilities of URLs;
determining a selection probability for a URL not in a URL search index using the URL prediction model;
comparing the selection probability of the URL to a selection probability threshold; and
based on the selection probability for the URL meeting the selection probability threshold, adding the URL to the URL search index.

2. The computer-implemented method of claim 1, wherein adding the URL to the URL search index occurs in near-real time upon determining that the selection probability of the URL meets the selection probability threshold.

3. The computer-implemented method of claim 1, further comprising generating a URL token index that includes URL terms and URL characters mapped to URL identifiers.

4. The computer-implemented method of claim 3, further comprising generating a set of URL identifier strings by converting a set of URLs using a tokenization model based on the URL token index.

5. The computer-implemented method of claim 4, wherein generating the URL language model predicts the syntax and structure of URL strings based on the tuned weights and parameters by learning URL architecture, URL hierarchy, URL authority, and URL freshness.

6. The computer-implemented method of claim 1, wherein generating the URL language model includes:
using a set of URL identifier strings to create the tuned weights and parameters of the URL language model; and
training the URL language model to inherently learn URL selection likelihoods.

7. The computer-implemented method of claim 1, wherein the URL language model is a masking language model or a causal language model trained to predict URL tokens in URL token strings.

8. The computer-implemented method of claim 1, wherein generating the URL prediction model includes duplicating the tuned weights and parameters of the URL language model without duplication of a language classifier layer of the URL language model.

9. The computer-implemented method of claim 8, wherein combining the tuned weights and parameters of the URL language model with a prediction classification layer includes adding a feed-forward layer and a softmax activation function to the tuned weights and parameters.

10. The computer-implemented method of claim 9, wherein generating the URL prediction model includes fine-tuning the prediction classification layer to determine the selection probabilities of the URLs.

11. The computer-implemented method of claim 10, wherein generating the URL prediction model includes freezing the tuned weights and parameters while fine-tuning the prediction classification layer to determine the selection probabilities of the URLs.

12. The computer-implemented method of claim 10, wherein generating the URL prediction model includes fine-tuning the prediction classification layer to determine additional probabilities of the URLs, including URL type information, URL network information, URL longevity, or included link longevity.

13. The computer-implemented method of claim 1, wherein comparing the selection probability of the URL to the selection probability threshold includes comparing the selection probability of the URL to a first selection probability threshold corresponding to adding URLs to the URL search index within a first time period.

14. The computer-implemented method of claim 13, wherein:
comparing the selection probability of the URL to the selection probability threshold includes comparing the selection probability of the URL to a second selection probability threshold corresponding to adding URLs to the URL search index within a second time period;
the second selection probability threshold is greater than the first selection probability threshold; and
the second time period has a shorter duration than the first time period.

15. A system for determining uniform resource locator (URL) characteristics using generative artificial intelligence (AI) models, comprising:
a URL language model generated to predict syntax and structure of URL strings and URL selection probabilities;
a URL prediction model generated to determine selection probabilities of URLs based on tuned weights and parameters of the URL language model;
a processing system having a processor; and
a computer memory including instructions that, when executed by the processing system, cause the system to carry out operations comprising:
identifying a URL not included in a URL search index;
determining a selection probability for the URL using the URL prediction model; and
based on the selection probability for the URL meeting a selection probability threshold, adding the URL to a URL search index.

16. The system of claim 15, further comprising identifying the URL while crawling an existing webpage.

17. The system of claim 15, further comprising:
in response to identifying an additional URL, determining an additional selection probability for the additional URL using the URL prediction model; and
based on determining that the additional selection probability does not meet the selection probability threshold, determining not to include the additional URL in the URL search index.

18. The system of claim 15, wherein the URL language model is a masking language model trained to predict URL tokens in URL token strings.

19. A computer-implemented method for determining uniform resource locator (URL) characteristics using generative artificial intelligence (AI) models, comprising:
generating a URL language model to predict syntax and structure of URL strings;
generating a URL prediction model based on tuned weights and parameters of the URL language model to determine selection probabilities of URLs;
in response to identifying a URL, determining a selection probability for the URL using the URL prediction model; and
based on the selection probability for the URL meeting a selection probability threshold, adding the URL to a URL search index.

20. The computer-implemented method of claim 19, wherein:
generating the URL language model includes creating the tuned weights and parameters of the URL language model to predict syntax and structure of URL strings; and
generating the URL prediction model includes combining the tuned weights and parameters of the URL language model with a prediction classification layer to determine the selection probabilities of URLs.
